(19) United States
(12) Patent Application Publication
(10) Pub. No.: US 2018/0242177 A1
(43) Pub. Date: Aug. 23, 2018

(54) Monitoring management method and apparatus

(71) Applicant: ZTE Corporation, Shenzhen, Guangdong (CN)

(72) Inventor: Hao Wu, Shenzhen (CN)

(21) Appl. No.: 15/569,518

(22) PCT Filed: Dec. 23, 2015
(86) PCT No.: PCT/CN2015/098403

§ 371 Date: Oct. 26, 2017

(30) Foreign Application Priority Data
Apr. 28, 2015 (CN) 201510209460.X

(51) Int. Cl. H04W 24/08; H04W 4/38; H04Q 9/00; H04L 12/26; H04W 4/70

(52) U.S. Cl. CPC H04W 24/08; H04W 4/38; H04Q 9/00; H04Q 2209/60; H04L 43/065; H04W 4/70; H04L 43/067

(57) ABSTRACT

The present disclosure provides a monitoring management method and apparatus. The method comprises: receiving a request message, sent by a monitoring initiator, for creating a resource, wherein the resource is used for monitoring management, and the request message at least comprises the following parameter: a monitoring event; creating, according to the request message, the resource, and creating, according to the parameter contained in the request message, an attribute of the resource; monitoring, according to the attribute of the resource, the monitoring event; and receiving and saving a monitoring report, wherein the monitoring report carries a monitoring result. The present disclosure solves the problem of resource waste during monitoring of a monitored object in the related art, thereby achieving the effect of avoiding resource waste.

### TECHNICAL FIELD

The disclosure relates to the field of communications, and particularly to a monitoring management method and device.

### BACKGROUND

With development of sciences and technologies, various communication networks play a more and more important role in people's lives. For example, a Machine to Machine (M2M) communication network is formed by various M2M nodes and a bearer network. The M2M nodes communicate with one another through the bearer network. Each M2M node includes at least an Application Entity (AE) or a common service entity.

An application entity is a logical unit that executes a practical M2M application, and a common service entity is a logical unit that manages and serves the application.

Communication between M2M applications is implemented through a common service entity, i.e. Common channel Signaling Equipment (CSE). The M2M applications are registered with the CSE, and then resources on the CSE are operated to implement interaction between the applications. As illustrated in FIG. 1, FIG. 1 is a diagram of an M2M system architecture in a related technology.

In an M2M system architecture, an application node is an end terminal for executing an application, such as a smart electric meter, a temperature measurement and control sensor, a fire alarm and an intelligent home appliance. An infrastructure node is a network-side server. An application registered with the infrastructure node may be a management platform of an M2M service provider.

In FIG. 1, an application entity AE1 on a network side is registered with CSE on an infrastructure node, and then the CSE on the infrastructure node is called as local CSE or registration CSE of the application entity AE1. Similarly, an AE2 is registered with the CSE on the infrastructure node, and then the CSE on the infrastructure node is called as local CSE or registration CSE of the AE2.

Interaction between the AE1 and the AE2 is implemented by mutually accessing resources created by the opposite parties on the registration CSE, and the AE2 needs to be connected to the CSE on the infrastructure node through a bearer network.

The AE1 may send a request to the CSE to request the CSE to monitor a state of a node where the AE2 is located, for example, to monitor whether the node is online and whether the node moves. However, it is to be noted that, when there are a plurality of the AEs1, each of the plurality of AEs1 are required to interact with the AE2 through the CSE if the AEs1 all need monitor the state of the node where the AE2 is located. This makes the CSE acquire the same state information of the AE2 for many times, which will cause resource waste.

In addition, with continuous extension of application scenarios, an original monitoring mechanism cannot meet a new requirement anymore. For example, when the AE1 needs to know about how many online terminals are in a specified region, for example, when a management platform of a smart grid needs to know about how many online (i.e., normally running) smart electric meters of a community every month, it is difficult for original monitoring management only for a single terminal to process such a case.

For the problem of resource waste formed when a target to be monitored is monitored in the related technology, there is yet no effective solution.

### SUMMARY

The disclosure provides a monitoring management method and device, so as to at least solve the problem of resource waste formed when a target to be monitored is monitored in the related technology.

According to an aspect of the disclosure, a monitoring management method is provided, which may include that: a request message for requesting creation of a resource is received from a monitoring initiator, wherein the resource may be configured for monitoring management, and the request message may include at least the following parameter: an event to be monitored; the resource is created according to the request message, and an attribute of the resource is created according to the parameter included in the request message; the event to be monitored is monitored according to the attribute of the resource; and a monitoring report is received and stored, wherein the monitoring report may contain a monitoring result.

Alternatively, the request message may further include at least one of an identifier of a target to be monitored, a first monitoring identifier for identifying a monitoring task, a processing manner performed after occurrence of the event to be monitored, a monitoring time length, a monitoring report number, a time when a monitoring ends and a time when a monitoring starts.

Alternatively, the step that the event to be monitored is monitored according to the attribute of the resource may include that: a monitoring request message is sent to a bearer network according to the attribute of the resource, wherein the monitoring request message may be configured to instruct the bearer network to monitor the event to be monitored, and the monitoring request message may include the attribute of the resource.

Alternatively, after the step that the monitoring request message is sent to the bearer network according to the attribute of the resource, the method may further include that: a second monitoring identifier allocated by the bearer network is received; and the received second monitoring identifier is stored in the resource.

Alternatively, before the step that the event to be monitored is monitored according to the attribute of the resource, the method may further include that: a third monitoring identifier is allocated; and a third monitoring identifier attribute is created for the resource, and a value of the created third monitoring identifier attribute is set to be the allocated third monitoring identifier.

Alternatively, after the step that the monitoring request message is sent to the bearer network according to the attribute of the resource, the method may further include that: a first monitoring stopping request message is sent to the bearer network, wherein the first monitoring stopping request message may include a first monitoring identifier attribute of the resource, and the first monitoring stopping request message may be configured to instruct the bearer network to stop monitoring corresponding to a value of the first monitoring identifier attribute.

Alternatively, after the step that the monitoring request message is sent to the bearer network according to the attribute of the resource, the method may further include that: a first monitoring updating request message is sent to the bearer network, wherein the first monitoring updating request message may include the first monitoring identifier attribute of the resource and at least one of attributes obtained by updating an identifier attribute of the target to be monitored, an attribute indicating an event to be monitored, an attribute indicating a processing manner performed after occurrence of the event, a monitoring time length attribute, a monitoring report number attribute, an attribute indicating a time when a monitoring ends and an attribute indicating a time when a monitoring starts, respectively.

Alternatively, the step that the monitoring report is stored may include that: the monitoring report is stored in the resource; and/or, the monitoring report is stored in another pre-created resource except the resource.

Alternatively, after the step that the received second monitoring identifier is stored in the resource, the method may further include that: a second monitoring stopping request message is sent to the bearer network, wherein the second monitoring stopping request message may include a second monitoring identifier attribute of the resource, and the second monitoring stopping request message may be configured to instruct the bearer network to stop monitoring corresponding to a value of the second monitoring identifier attribute.

Alternatively, after the step that the received second monitoring identifier is stored in the resource, the method may further include that: a second monitoring updating request message is sent to the bearer network, wherein the second monitoring updating request message may include the second monitoring identifier attribute of the resource and at least one of attributes obtained by updating the identifier attribute of the target to be monitored, the attribute of the event to be monitored, the attribute indicating the processing manner performed after occurrence of the event, the monitoring time length attribute, the monitoring report number attribute, the attribute indicating the time when the monitoring ends and the attribute indicating the time when the monitoring starts, respectively.

Alternatively, after the step that the event to be monitored is monitored according to the attribute of the resource, the method may further include that: a third monitoring stopping request message is sent to the bearer network, wherein the third monitoring stopping request message may include the third monitoring identifier attribute of the resource, and the third monitoring stopping request message may be configured to instruct the bearer network to stop monitoring corresponding to the value of the third monitoring identifier attribute.

Alternatively, after the step that the event to be monitored is monitored according to the attribute of the resource, the method may further include that: a third monitoring updating request message is sent to the bearer network, wherein the third monitoring updating request message may include the third monitoring identifier attribute of the resource and at least one of attributes obtained by updating the identifier attribute of the target to be monitored, the attribute of the event to be monitored, the attribute indicating the processing manner performed after occurrence of the event, the monitoring time length attribute, the monitoring report number attribute, the attribute indicating the time when the monitoring ends and the attribute indicating the time when the monitoring starts, respectively.

According to another aspect of the disclosure, a monitoring management device is provided, which may include: a first receiving module, configured to receive from a monitoring initiator a request message for requesting creation of a resource, wherein the resource may be configured for monitoring management, and the request message may include at least the following parameter: an event to be monitored; a creation module, configured to create the resource according to the request message, and create an attribute of the resource according to the parameter included in the request message; a monitoring module, configured to monitor the event to be monitored according to the attribute of the resource; and a first storage module, configured to receive and store a monitoring report, wherein the monitoring report may contain a monitoring result.

Alternatively, the request message may further include at least one of an identifier of a target to be monitored, a first monitoring identifier for identifying a monitoring task, a processing manner performed after occurrence of the event to be monitored, a monitoring time length, a monitoring report number, a time when a monitoring ends and a time when a monitoring starts.

Alternatively, the monitoring module may include: sending a monitoring request message to a bearer network according to the attribute of the resource, wherein the monitoring request message may be configured to instruct the bearer network to monitor the event to be monitored, and the monitoring request message may include the attribute of the resource.

Alternatively, the device may further include: a second receiving module, configured to receive a second monitoring identifier allocated by the bearer network; and a second storage module, configured to store the received second monitoring identifier in the resource.

Alternatively, the device may further include: an allocation module, configured to allocate a third monitoring identifier; and a second creation module, configured to create a third monitoring identifier attribute for the resource, and set a value of the created third monitoring identifier attribute to be the allocated third monitoring identifier.

Alternatively, the device may further include: a first sending module, configured to send a first monitoring stopping request message to the bearer network, wherein the first monitoring stopping request message may include a first monitoring identifier attribute of the resource, and the first monitoring stopping request message may be configured to instruct the bearer network to stop monitoring corresponding to a value of the first monitoring identifier attribute.

Alternatively, the device may further include: a second sending module, configured to send a first monitoring updating request message to the bearer network, wherein the first monitoring updating request message may include the first monitoring identifier attribute of the resource and at least one of attributes obtained by updating an identifier attribute of the target to be monitored, an event to be monitored attribute, an attribute indicating a processing manner performed after occurrence of the event, a monitoring time length attribute, a monitoring report number attribute, an attribute indicating a time when a monitoring ends and an attribute indicating a time when a monitoring starts, respectively.

Alternatively, the first storage module may include: a first storage unit, configured to store the monitoring report in the resource; and/or, a second storage unit, configured to store the monitoring report in another pre-created resource except the resource.

Alternatively, the device may further include: a third sending module, configured to, after the received second monitoring identifier is stored in the resource, send a second monitoring stopping request message to the bearer network, wherein the second monitoring stopping request message may include a second monitoring identifier attribute of the resource, and the second monitoring stopping request message may be configured to instruct the bearer network to stop monitoring corresponding to a value of the second monitoring identifier attribute.

Alternatively, the device may further include: a fourth sending module, configured to, after the received second monitoring identifier is stored in the resource, send a second monitoring updating request message to the bearer network, wherein the second monitoring updating request message may include the second monitoring identifier attribute of the resource and at least one of attributes obtained by updating the identifier attribute of the target to be monitored, the attribute of the event to be monitored, the attribute indicating the processing manner performed after occurrence of the event, the monitoring time length attribute, the monitoring report number attribute, the attribute indicating the time when the monitoring ends and the attribute indicating the time when the monitoring starts, respectively.

Alternatively, the device may further include: a fifth sending module, configured to, after the event to be monitored is monitored according to the attribute of the resource, send a third monitoring stopping request message to the bearer network, wherein the third monitoring stopping request message may include the third monitoring identifier attribute of the resource, and the third monitoring stopping request message may be configured to instruct the bearer network to stop monitoring corresponding to the value of the third monitoring identifier attribute.

Alternatively, the device may further include: a sixth sending module, configured to, after the event to be monitored is monitored according to the attribute of the resource, send a third monitoring updating request message to the bearer network, wherein the third monitoring updating request message may include the third monitoring identifier attribute of the resource and at least one of attributes obtained by updating the identifier attribute of the target to be monitored, the attribute of the event to be monitored, the attribute indicating the processing manner performed after occurrence of the event, the monitoring time length attribute, the monitoring report number attribute, the attribute indicating the time when the monitoring ends and the attribute indicating the time when the monitoring starts, respectively.

According to the disclosure, the request message configured to create the resource is received from the monitoring initiator, wherein the resource is configured for monitoring management, and the request message contains at least the following parameter: the event to be monitored; the resource is created according to the request message, and the attribute of the resource is created according to the parameter included in the request message; the event to be monitored is monitored according to the attribute of the resource; and the monitoring report is received and stored, wherein the monitoring report contains the monitoring result. The problem of resource waste formed when the target to be monitored is monitored in the related technology is solved, and an effect of avoiding resource waste is further achieved.

### BRIEF DESCRIPTION OF DRAWINGS

The drawings described here are intended to provide a further understanding to the disclosure, and form a part of the disclosure. Illustrated embodiments of the disclosure and descriptions thereof are adopted to explain the disclosure and not intended to form improper limits to the disclosure. In the drawings:

FIG. 1 is a diagram of an M2M system architecture in the related technology.

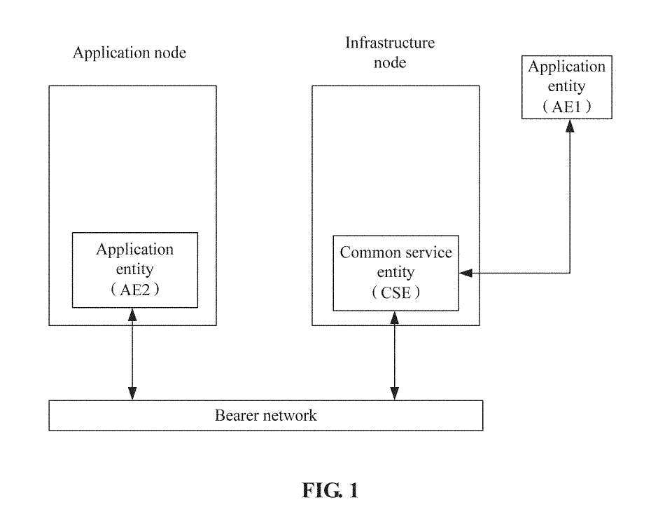

FIG. 2 is a flowchart of a monitoring management method according to an embodiment of the disclosure.

FIG. 3 is a block diagram illustrating a structure of a monitoring management device according to an embodiment of the disclosure.

FIG. 4 is a block diagram illustrating a first preferred structure of a monitoring management device according to an embodiment of the disclosure.

FIG. 5 is a block diagram illustrating a second preferred structure of a monitoring management device according to an embodiment of the disclosure.

FIG. 6 is a block diagram illustrating a third preferred structure of a monitoring management device according to an embodiment of the disclosure.

FIG. 7 is a block diagram illustrating a fourth preferred structure of a monitoring management device according to an embodiment of the disclosure.

FIG. 8 is a block diagram illustrating a structure of a first storage module 38 in a monitoring management device according to an embodiment of the disclosure.

### DETAILED DESCRIPTION

The disclosure will be described below in detail with reference to the drawings in conjunction with the embodiments. It is to be noted that the embodiments in the disclosure and characteristics in the embodiments may be combined as long as they do not conflicts with each other.

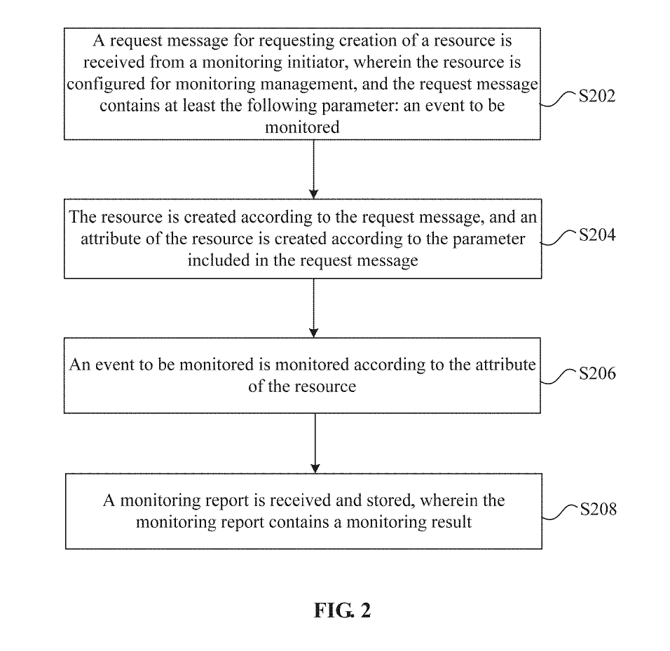

An embodiment provides a monitoring management method. FIG. 2 is a flowchart of a monitoring management method according to an embodiment of the disclosure. As illustrated in FIG. 2, the flow includes the following steps.

In Step S202, a request message for requesting creation of a resource is received from a monitoring initiator. The resource is configured for monitoring management. The request message contains at least the following parameter: an event to be monitored.

In Step S204, the resource is created according to the request message, and an attribute of the resource is created according to the parameter included in the request message.

In Step S206, the event to be monitored is monitored according to the attribute of the resource.

In Step S208, a monitoring report is received and stored. Here, the monitoring report contains a monitoring result.

Here, the attribute of the created resource may correspond to the respective parameters contained in the request message. That is, a number of parameters contained in the request message is the same as a number of attributes created for the resource and corresponding to the parameters. By the steps, after the request message configured to request for creating the resource is received from the monitoring initiator, the resource configured for monitoring management is created, the event to be monitored is monitored according to the attribute of the resource, and the monitoring result is received and stored. In such a manner, when there is another monitor requesting for monitoring a target to be monitored, the stored monitoring result may be directly sent to the other monitor. As such, information interaction with the target to be monitored is reduced, and resource waste is avoided. Therefore, the problem of resource waste formed when the target to be monitored is monitored in the related technology is solved, and an effect of avoiding resource waste is further achieved. Here, the event to be monitored may refer to a content to be monitored by a bearer network, such as the following event definitions 1) and 2).

The definition 1) defines whether a terminal is offline, configured to instruct the bearer network to detect an online state of the terminal and send the monitoring report to CSE once the terminal is offline. Here, such an event requires an identifier parameter of the target to be monitored.

The definition 2) defines a position change of the terminal, configured to instruct the bearer network to send the monitoring report to the CSE when a change in the position of the terminal is detected. Here, such an event requires the identifier parameter of the target to be monitored.

The definition 3) defines a number of terminals in a specified region: configured to instruct the bearer network to feed back a number of online terminals in the specified region.

There may be multiple types of parameters contained in the request message. In an optional embodiment, the request message may further include at least one of an identifier of a target to be monitored, a first monitoring identifier for identifying a monitoring task, a processing manner performed after occurrence of the event to be monitored, a monitoring time length, a monitoring report number, a time when a monitoring ends and a time when a monitoring starts.

When the event to be monitored is monitored, the event to be monitored may be monitored through the bearer network. In an optional embodiment, the step that the event to be monitored is monitored according to the attribute of the resource includes that: a monitoring request message is sent to the bearer network according to the attribute of the resource. Here, the monitoring request message may be configured to instruct the bearer network to monitor the event to be monitored. The monitoring request message may contain the attribute of the resource. Here, the request message may contain all attributes of the resource. That is, when the event to be monitored is to be monitored, a monitoring process may be implemented by virtue of the bearer network. Therefore, the monitoring report may also be monitoring result information which may be reported by the bearer network and related to the event to be monitored.

There are multiple allocation manners for the monitoring identifier. In an optional embodiment, after the step that the monitoring request message is sent to the bearer network according to the attribute of the resource, the method may further include that: a second monitoring identifier allocated by the bearer network is received; and the received second monitoring identifier is stored in the resource. It is to be noted that the second monitoring identifier may be allocated by the bearer network no matter whether the attribute of the resource includes an attribute corresponding to a first monitoring identifier. It is also to be noted that the first monitoring identifier and the second monitoring identifier may be the same, and may also be different from each other. It is the bearer network which executes the monitoring. Thus, the bearer network may still allocate the monitoring identifier (i.e. the second monitoring identifier) according to own naming rule and feed back the allocated monitoring identifier even though the monitoring identifier has been allocated in advance. Then a value of a monitoring identifier attribute of the resource is changed into the monitoring identifier allocated by the bearer network.

In another optional embodiment, the monitoring identifier may also be allocated in the following manner. Before the step that the event to be monitored is monitored according to the attribute of the resource, the method may further include that: a third monitoring identifier is allocated; and a third monitoring identifier attribute is created for the resource, and a value of the created third monitoring identifier attribute is set to be the allocated third monitoring identifier. The third monitoring identifier may be the same as or different from the abovementioned first monitoring identifier. Similarly, the third monitoring identifier may be the same as or different from the abovementioned second monitoring identifier. That is, the first monitoring identifier, the second monitoring identifier and the third monitoring identifier may be the same, and may also be different from each other, and two of them may be the same. It is to be noted that the third monitoring identifier may be allocated no matter whether the request message includes the first monitoring identifier or not. This unit is a unit performing monitoring management, so that a new monitoring identifier may also be allocated according to own rule, and the allocated third monitoring identifier is fed back to the monitoring initiator.

When monitoring of the event to be monitored is finished or monitoring of the event to be monitored is required to be stopped for other reasons, a monitoring behavior may be stopped in the following manner. In an optional embodiment, after the step that the monitoring request message is sent to the bearer network according to the attribute of the resource, the method may further include that: a first monitoring stopping request message is sent to the bearer network. Here, the first monitoring stopping request message may contain a first monitoring identifier attribute of the resource. The first monitoring stopping request message is configured to instruct the bearer network to stop monitoring corresponding to a value of the first monitoring identifier attribute.

In an optional embodiment, the monitoring behavior may also be updated. Updating may be updating of a node to be monitored, or updating of a parameter such as the event to be monitored and the monitoring time length. Here, after the step that the monitoring request message is sent to the bearer network according to the attribute of the resource, the method may further include that: a first monitoring updating request message is sent to the bearer network. Here, the first monitoring updating request message may contain the first monitoring identifier attribute of the resource and at least one of attributes obtained by updating an identifier attribute of the target to be monitored, an event to be monitored attribute, an attribute indicating a processing manner performed after occurrence of the event, a monitoring time length attribute, a monitoring report number attribute, an attribute indicating a time when a monitoring ends and an attribute indicating a time when a monitoring starts, respectively.

When the monitoring report is stored, the monitoring report may be stored in the created resource, or the monitoring report may be stored in another resource. For example, a dedicated resource such as a “container” resource configured to store the monitoring report may be created, or the monitoring report is stored in another created resource. Of course, the monitoring result may be returned in form of monitoring report, or in another manner.

From the above descriptions about the embodiment, there are multiple manners for allocating the monitoring identifier. One or more monitoring identifiers may be allocated in different allocation manners. When monitoring is required to be stopped, monitoring stopping requests may be sent for the allocated monitoring identifiers. In an optional embodiment, after the step that the received second monitoring identifier is stored in the resource, the method may further include that: a second monitoring stopping request message is sent to the bearer network. Here, the second monitoring stopping request message includes a second monitoring identifier attribute of the resource, and the second monitoring stopping request message is configured to instruct the bearer network to stop monitoring corresponding to a value of the second monitoring identifier attribute.

Similarly, when the monitoring behavior is required to be updated, monitoring updating requests may be sent for the allocated monitoring identifiers. In an optional embodiment, after the step that the received second monitoring identifier is stored in the resource, the method may further include that: a second monitoring updating request message is sent to the bearer network. Here, the second monitoring updating request message includes the second monitoring identifier attribute of the resource and at least one of attributes obtained by updating the identifier attribute of the target to be monitored, the attribute of the event to be monitored, the attribute indicating the processing manner performed after occurrence of the event, the monitoring time length attribute, the monitoring report number attribute, the attribute indicating the time when the monitoring ends and the attribute indicating the time when the monitoring starts, respectively.

In an optional embodiment, after the step that the event to be monitored is monitored according to the attribute of the resource, the method may further include that: a third monitoring stopping request message is sent to the bearer network. Here, the third monitoring stopping request message includes the third monitoring identifier attribute of the resource. The third monitoring stopping request message is configured to instruct the bearer network to stop monitoring corresponding to the value of the third monitoring identifier attribute.

In an optional embodiment, after the step that the event to be monitored is monitored according to the attribute of the resource, the method may further include that: a third monitoring updating request message is sent to the bearer network. Here, the third monitoring updating request message may contain the third monitoring identifier attribute of the resource and at least one of attributes obtained by updating the identifier attribute of the target to be monitored, the attribute of the event to be monitored, the attribute indicating the processing manner performed after occurrence of the event, the monitoring time length attribute, the monitoring report number attribute, the attribute indicating the time when the monitoring ends and the attribute indicating the time when the monitoring starts, respectively.

An embodiment further provides a monitoring management device. The device is configured to implement the abovementioned embodiments and preferred implementation modes, and what has been described will not be elaborated. For example, term “module”, as used below, may be a combination of software and/or hardware capable of realizing a predetermined function. Although the device described in the following embodiment is preferably implemented with software, implementation with hardware or a combination of the software and the hardware is also possible and conceivable.

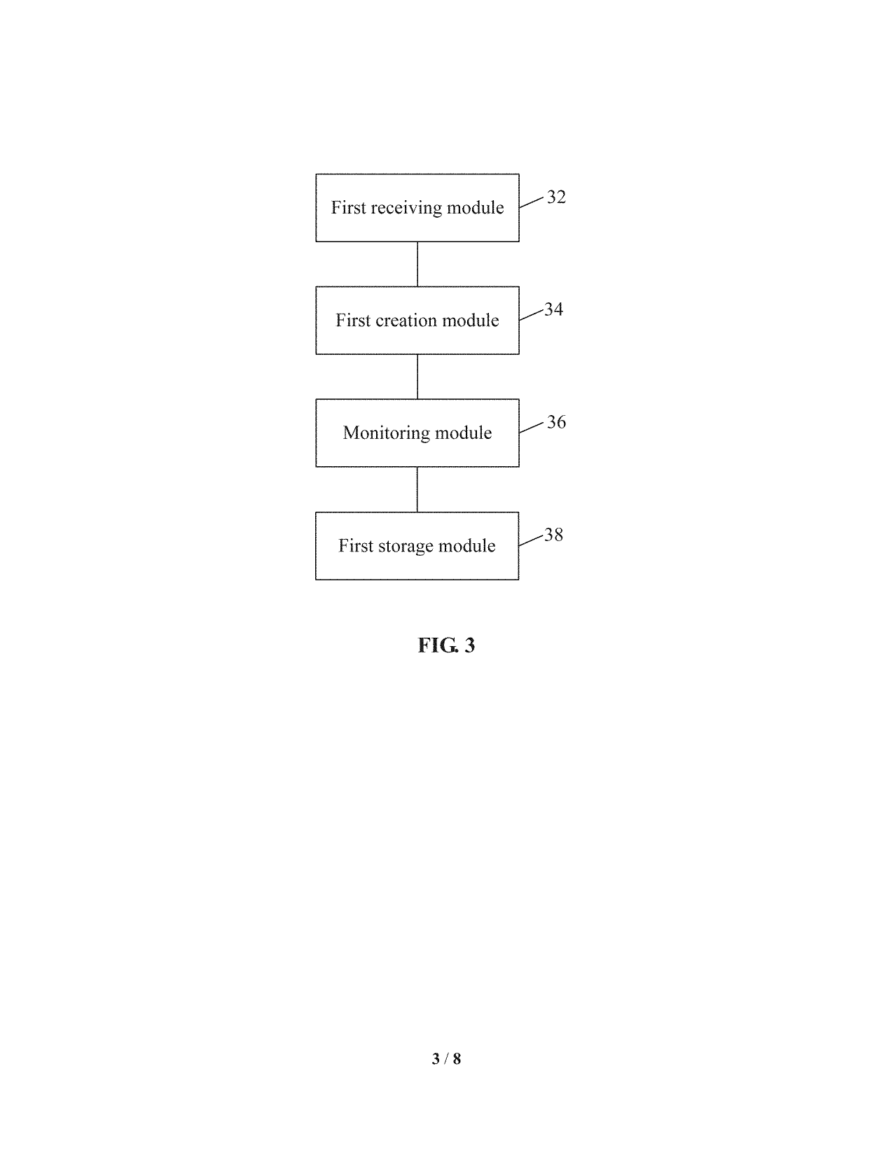

FIG. 3 is a block diagram illustrating a structure of a monitoring management device according to an embodiment of the disclosure. As illustrated in FIG. 3, the device includes a first receiving module 32, a first creation module 34, a monitoring module 36 and a first storage module 38. The device will be described below.

The first receiving module 32 is configured to receive from a monitoring initiator a request message for requesting creation of a resource. Here, the resource may be configured for monitoring management. The request message may contain at least the following parameter: an event to be monitored. The creation module 34 is connected to the first receiving module 32 and configured to create the resource according to the request message, and create an attribute of the resource according to the parameter included in the request message. The monitoring module 36 is connected to the first creation module 34 and configured to monitor the event to be monitored according to the attribute of the resource. The first storage module 38 is connected to the monitoring module 36 and configured to receive and store a monitoring report. Here, the monitoring report contains a monitoring result.

Here, the request message may further include at least one of an identifier of a target to be monitored, a first monitoring identifier for identifying a monitoring task, a processing manner performed after occurrence of the event to be monitored, a monitoring time length, a monitoring report number, a time when a monitoring ends and a time when a monitoring starts.

The monitoring module 36 may send a monitoring request message to a bearer network according to the attribute of the resource. Here, the monitoring request message may be configured to instruct the bearer network to monitor the event to be monitored. The monitoring request message may include the attribute of the resource.

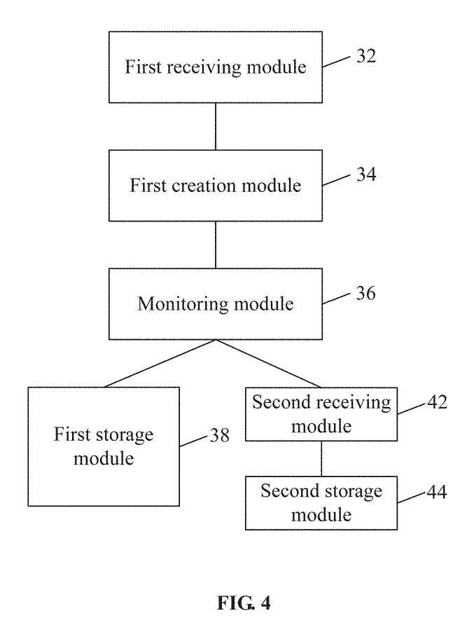

FIG. 4 is a block diagram illustrating a first preferred structure of a monitoring management device according to an embodiment of the disclosure. As illustrated in FIG. 4, the device may further include, in addition to all the modules illustrated in FIG. 3, a second receiving module 42 and a second storage module 44. The device will be described below.

The second receiving module 42, may be connected to the monitoring module 36, and may be configured to receive a second monitoring identifier allocated by the bearer network. The second storage module 44 may be connected to the second receiving module 42, and may be configured to store the received second monitoring identifier in the resource.

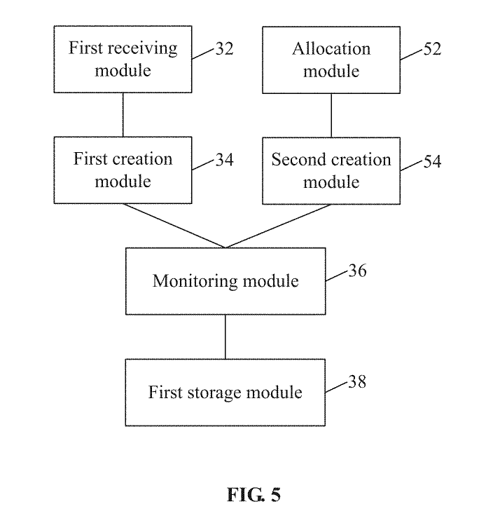

FIG. 5 is a block diagram illustrating a second preferred structure of a monitoring management device according to an embodiment of the disclosure. As illustrated in FIG. 5, the device may further include, in addition to all the modules as illustrated in FIG. 3, an allocation module 52 and a second creation module 54. The device will be described below.

The allocation module 52 may be configured to allocate a third monitoring identifier. The second creation module 54 may be connected to the allocation module 52 and the monitoring module 36, and may be configured to create a third monitoring identifier attribute for the resource, and set a value of the created third monitoring identifier attribute to be the allocated third monitoring identifier.

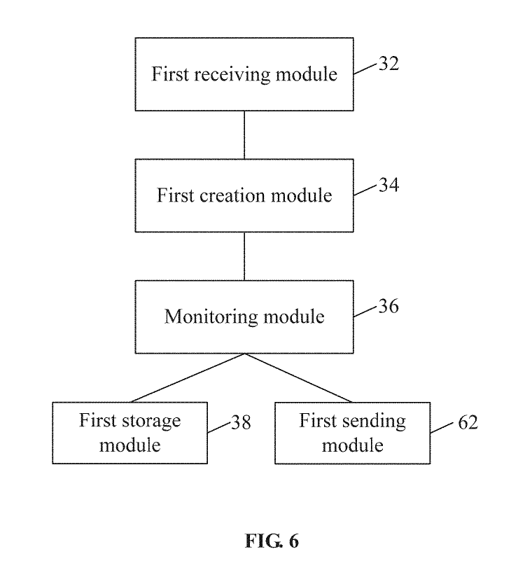

FIG. 6 is a block diagram illustrating a third preferred structure of a monitoring management device according to an embodiment of the disclosure. As illustrated in FIG. 6, the device may further include, in addition to all the modules illustrated in FIG. 3, a first sending module 62. The device will be described below.

The first sending module 62 may be connected to the monitoring module 36, and may be configured to send a first monitoring stopping request message to the bearer network. Here, the first monitoring stopping request message may include a first monitoring identifier attribute of the resource. The first monitoring stopping request message may be configured to instruct the bearer network to stop monitoring corresponding to a value of the first monitoring identifier attribute.

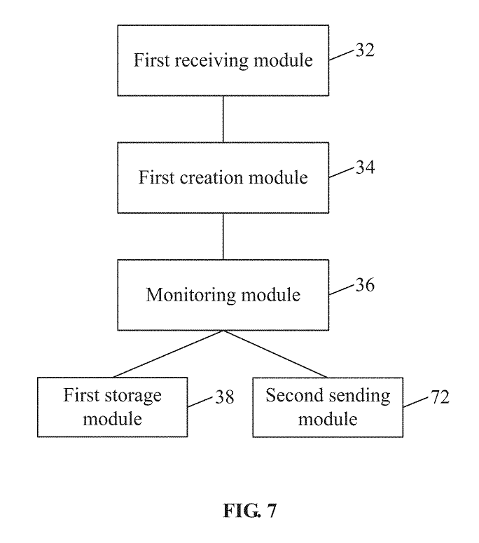

FIG. 7 is a block diagram illustrating a fourth preferred structure of a monitoring management device according to an embodiment of the disclosure. As illustrated in FIG. 7, the device may further include, in addition to all the modules as illustrated in FIG. 3, a second sending module 72. The device will be described below.

The second sending module 72 may be connected to the monitoring module 36, and may be configured to send a first monitoring updating request message to the bearer network. Here, the first monitoring updating request message may include the first monitoring identifier attribute of the resource and at least one of attributes obtained by updating an identifier attribute of the target to be monitored, an attribute indicating an event to be monitored, an attribute indicating a processing manner performed after occurrence of the event, a monitoring time length attribute, a monitoring report number attribute, an attribute indicating a time when a monitoring ends and an attribute indicating a time when a monitoring starts, respectively.

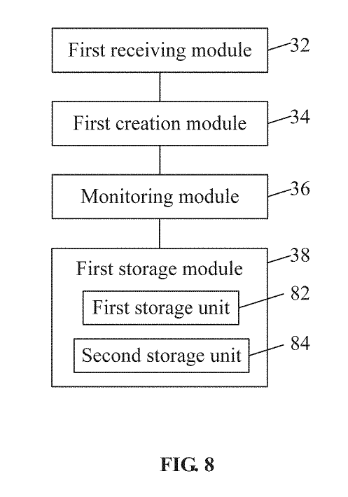

FIG. 8 is a block diagram illustrating a structure of a first storage module 38 in a monitoring management device according to an embodiment of the disclosure. As illustrated in FIG. 8, the first storage module 38 may include a first storage unit 82 and/or a second storage unit 84. The storage module 38 will be described below.

The first storage unit 82 may be configured to store the monitoring report in the resource. The second storage unit 84 may be configured to store the monitoring report in another pre-created resource except the resource.

In an optional embodiment, a monitoring management device may be further provided. The device may further include, in addition to all the modules as illustrated in FIG. 4, a third sending module. The third sending module may be connected to the second storage module 44, and may be configured to, after the received second monitoring identifier is stored in the resource, send a second monitoring stopping request message to the bearer network. Here, the second monitoring stopping request message may include a second monitoring identifier attribute of the resource. The second monitoring stopping request message may be configured to instruct the bearer network to stop monitoring corresponding to a value of the second monitoring identifier attribute.

In an optional embodiment, a monitoring management device may be further provided. The device may further include, in addition to all the modules as illustrated in FIG. 4, a fourth sending module. The fourth sending module may be connected to the second storage module 44, and may be configured to, after the received second monitoring identifier is stored in the resource, send a second monitoring updating request message to the bearer network. Here, the second monitoring updating request message may include the second monitoring identifier attribute of the resource and at least one of attributes obtained by updating the identifier attribute of the target to be monitored, the attribute of the event to be monitored, the attribute indicating the processing manner performed after occurrence of the event, the monitoring time length attribute, the monitoring report number attribute, the attribute indicating the time when the monitoring ends and the attribute indicating the time when the monitoring starts, respectively.

In an optional embodiment, a monitoring management device may be further provided. The device may further include, in addition to all the modules illustrated in FIG. 5, a fifth sending module. The fifth sending module may be connected to the monitoring module 36, and may be configured to, after the event to be monitored is monitored according to the attribute of the resource, send a third monitoring stopping request message to the bearer network. Here, the third monitoring stopping request message includes the third monitoring identifier attribute of the resource. The third monitoring stopping request message is configured to instruct the bearer network to stop monitoring corresponding to the value of the third monitoring identifier attribute.

In an optional embodiment, a monitoring management device may be further provided. The device may further include, in addition to all the modules as illustrated in FIG. 5, a sixth sending module. The sixth sending module may be connected to the monitoring module 36, and may be configured to, after the event to be monitored is monitored according to the attribute of the resource, send a third monitoring updating request message to the bearer network. Here, the third monitoring updating request message may include the third monitoring identifier attribute of the resource and at least one of attributes obtained by updating the identifier attribute of the target to be monitored, the attribute indicating the event to be monitored, the attribute indicating the processing manner performed after occurrence of the event, the monitoring time length attribute, the monitoring report number attribute, the attribute indicating the time when the monitoring ends and the attribute indicating the time when the monitoring starts, respectively.

A method provided by the disclosure for monitoring an application node through CSE management will be described below in combination with a specific embodiment.

1: An initiator (which may be an AE or CSE) (equivalent to the abovementioned monitoring initiator) sends a resource creation request message (equivalent to the abovementioned request message) to registration CSE. Here, the resource creation request message may include at least one of the following parameter combinations:

1) a resource type (which may be monitoring management), a target to be monitored (which may be an identifier of the monitored node) and an event to be monitored (which may be defined according to an event required to be monitored);

2) the resource type, the target to be monitored, the event to be monitored and a monitoring identifier (equivalent to the abovementioned first monitoring identifier). Here, the monitoring identifier is used for identifying a monitoring task, the monitoring task may indicate that a specified event to be monitored of the specified target to be monitored will be detected, and the identifier may be configured to identify a monitoring process during interaction with a bearer network:

3) the resource type, the target to be monitored, the event to be monitored and a processing manner performed after occurrence of the event. Here, the processing manner after occurrence of the event may be a processing manner performed after the bearer network detects occurrence of the defined event. For example, a connection with the network is cut off and data receiving and sending scheduling units of the node are reduced;

4) the resource type, the target to be monitored, the event to be monitored and a monitoring time length. Here, the monitoring time length may be a duration of the monitoring task:

5) the resource type, the target to be monitored, the event to be monitored and a monitoring report number. Here, the monitoring report number is a number of monitoring reports sent by the bearer network to the CSE after occurrence of the defined event is detected, and the monitoring report number refers to how many times will the bearer network send the monitoring report;

6) the resource type, the target to be monitored, the event to be monitored and a time when a monitoring ends. Here, the time when the monitoring ends indicates an execution ending time of the monitoring task:

7) the resource type, the target to be monitored, the event to be monitored and a time when a monitoring starts. Here, the time when the monitoring starts may indicate that the monitoring task is started at a specified time;

8) the resource type, the target to be monitored, the event to be monitored, the time when the monitoring starts and the monitoring time length:

9) the resource type, the target to be monitored, the event to be monitored, the time when the monitoring starts and the time when the monitoring ends; and

10) the resource type, the event to be monitored and the monitoring time length.

It is to be noted that the parameter “processing manner after occurrence of the event” in the combination 3) may be added into the combinations 4)-10), thereby forming new combinations 11)-16).

The parameter “monitoring identifier” in the combination 2) may be added into the combinations 3)-16), thereby forming new combinations 27)-30).

Here, there are two main scenarios with the “monitoring identifier” and without the “monitoring identifier”. When the resource creation request message does not include the monitoring identifier, the monitoring identifier may be acquired in the following two manners. A first manner of the two manners is that the registration CSE allocates the monitoring identifier (when the monitoring identifier is allocated by the CSE, the allocated monitoring identifier is a third monitoring identifier) and sends it to the bearer network. The other manner of the two manners is allocation by the bearer network, and the bearer network allocates the monitoring identifier (when the monitoring identifier is allocated by the bearer network, the allocated monitoring identifier is a second monitoring identifier) after receiving a monitoring request of the registration CSE and then sends it to the registration CSE.

2: After receiving a resource creation request, the registration CSE verifies whether it supports a resource of a “monitoring management” type or not, verifies whether the initiator has a resource creation right or not, and if verification succeeds, create the resource of the “monitoring management” type and creates an attribute for the resource of the “monitoring management” type according to a parameter included in the resource creation request.

Here, the attribute may be created in two manners.

A first manner: the registration CSE creates a corresponding attribute for each parameter in each combination in 1. For example, for the combination 1), the registration CSE creates an attribute “monitoring target”, of which a value is set to be a value of the parameter “monitoring target” in the resource creation request message, and creates an attribute “monitoring event”, of which a value is set to be a value of the parameter “monitoring event” in the resource creation request message.

A second manner: the registration CSE creates an attribute “monitoring task”, and then places all parameters related to the monitoring task in the attribute.

3: The registration CSE creates a resource of a “container” type associated with the resource of the “monitoring management” type to store a monitoring report sent by the bearer network.

4: The registration CSE sends a monitoring request message to the bearer network. Here, the parameters, except the resource type, in each combination in 1 are included, and may be collectively referred to as “monitoring parameter” herein.

5: The bearer network receives the monitoring request message, and when the request message includes no monitoring identifier, allocates the monitoring identifier for the monitoring task in the current monitoring request message, and contains it in a response message for sending to the registration CSE, and the registration CSE stores the monitoring identifier as an attribute.

6: The registration CSE sends a monitoring stopping request message to the bearer network, the request message including the monitoring identifier. Here, when the monitoring identifier corresponds to the abovementioned first monitoring identifier, the monitoring stopping request message corresponds to the abovementioned first monitoring stopping request message; when the monitoring identifier corresponds to the abovementioned second monitoring identifier, the monitoring stopping request message corresponds to the abovementioned second monitoring stopping request message; and when the monitoring identifier corresponds to the abovementioned third monitoring identifier, the monitoring stopping request message corresponds to the abovementioned third monitoring stopping request message.

7: The registration CSE sends a monitoring updating request message to the bearer network, the request message including the monitoring identifier, and a monitoring parameter required to be updated. Here, the monitoring parameter required to be updated may at least include one or more of the following parameters:

1) the event to be monitored;

2) the processing manner after occurrence of the event:

3) the monitoring time length;

4) the time when the monitoring starts;

5) the time when the monitoring ends;

6) the monitoring report number; and

7) the identifier of the target to be monitored.

Here, when the monitoring updating request message is sent, if the monitoring identifier included in the monitoring updating request message corresponds to the abovementioned first monitoring identifier, the monitoring updating request message corresponds to the abovementioned first monitoring updating request message; if the monitoring identifier included in the monitoring updating request message corresponds to the abovementioned second monitoring identifier, the monitoring updating request message corresponds to the abovementioned second monitoring updating request message; and if the monitoring identifier included in the monitoring updating request message corresponds to the abovementioned third monitoring identifier, the monitoring updating request message corresponds to the abovementioned third monitoring updating request message.

Obviously, those skilled in the art should know that each module or each step of the disclosure may be implemented by a general purpose computing device. The modules or steps may be concentrated on a single computing device or distributed on a network formed by a plurality of computing devices, and may alternatively be implemented by program codes executable for the computing devices, so that the modules or steps may be stored in a storage device for execution with the computing devices. The illustrated or described steps may be executed in sequences different from those described here in some circumstances, or may form each integrated circuit module respectively, or multiple modules or steps therein may form a single integrated circuit module for implementation. As a consequence, the disclosure is not limited to any specific hardware and software combination.

The above is only the preferred embodiment of the disclosure and not intended to limit the disclosure. For those skilled in the art, the disclosure may have various modifications and variations. Any modifications, equivalent replacements, improvements and the like made within the spirit and principle of the disclosure shall fall within the scope of protection of the disclosure.

### INDUSTRIAL APPLICABILITY

As mentioned above, the monitoring management method and device provided by the embodiments of the disclosure have the following beneficial effects: the problem of resource waste formed when the target to be monitored is monitored in the related technology is solved, and an effect of avoiding resource waste is further achieved.

1. A monitoring management method, comprising:
receiving from a monitoring initiator a request message for requesting creation of a resource, wherein the resource is configured for monitoring management, and the request message contains at least the following parameter: an event to be monitored;
creating the resource according to the request message, and creating an attribute of the resource according to the parameter contained in the request message;
monitoring the event to be monitored according to the attribute of the resource to obtain a monitoring report; and
receiving and storing the monitoring report, wherein the monitoring report contains a monitoring result.

2. The method according to claim 1, wherein the request message further comprises at least one of an identifier of a target to be monitored, a first monitoring identifier for identifying a monitoring task, a processing manner performed after occurrence of the event to be monitored, a monitoring time length, a monitoring report number, a time when a monitoring ends and a time when a monitoring starts.

3. The method according to claim 2, wherein monitoring the event to be monitored according to the attribute of the resource comprises:
sending a monitoring request message to a bearer network according to the attribute of the resource, wherein the monitoring request message is configured to instruct the bearer network to monitor the event to be monitored, and the monitoring request message contains the attribute of the resource.

4. The method according to claim 3, after sending the monitoring request message to the bearer network according to the attribute of the resource, further comprising:
receiving a second monitoring identifier allocated by the bearer network; and
storing the received second monitoring identifier in the resource.

5. The method according to claim 2, before monitoring the event to be monitored according to the attribute of the resource, further comprising:
allocating a third monitoring identifier; and
creating a third monitoring identifier attribute for the resource, and setting a value of the created third monitoring identifier attribute to be the allocated third monitoring identifier.

6. The method according to claim 3, after sending the monitoring request message to the bearer network according to the attribute of the resource, further comprising:
sending a first monitoring stopping request message to the bearer network, wherein the first monitoring stopping request message contains a first monitoring identifier attribute of the resource, and the first monitoring stopping request message is configured to instruct the bearer network to stop monitoring corresponding to a value of the first monitoring identifier attribute.

7. The method according to claim 3, after sending the monitoring request message to the bearer network according to the attribute of the resource, further comprising:
sending a first monitoring updating request message to the bearer network, wherein the first monitoring updating request message contains the first monitoring identifier attribute of the resource and at least one of attributes obtained by updating an identifier attribute of the target to be monitored, an event to be monitored attribute, an attribute indicating a processing manner performed after occurrence of the event, a monitoring time length attribute, a monitoring report number attribute, a time when a monitoring ends attribute and a time when a monitoring starts attribute, respectively.

8. The method according to claim 1, wherein storing the monitoring report comprises:
storing the monitoring report in the resource; and/or,
storing the monitoring report in another pre-created resource except the resource.

9. The method according to claim 4, after storing the received second monitoring identifier in the resource, further comprising:
sending a second monitoring stopping request message to the bearer network, wherein the second monitoring stopping request message contains a second monitoring identifier attribute of the resource, and the second monitoring stopping request message is configured to instruct the bearer network to stop monitoring corresponding to a value of the second monitoring identifier attribute.

10. The method according to claim 4, after storing the received second monitoring identifier in the resource, further comprising:
sending a second monitoring updating request message to the bearer network, wherein the second monitoring updating request message contains the second monitoring identifier attribute of the resource and at least one of attributes obtained by updating the identifier attribute of the target to be monitored, the attribute of the event to be monitored, the attribute indicating the processing manner performed after occurrence of the event, the monitoring time length attribute, the monitoring report number attribute, the attribute indicating the time when the monitoring ends and the attribute indicating the time when the monitoring starts, respectively.

11. The method according to claim 5, after monitoring the event to be monitored according to the attribute of the resource, further comprising:
sending a third monitoring stopping request message to the bearer network, wherein the third monitoring stopping request message contains the third monitoring identifier attribute of the resource, and the third monitoring stopping request message is configured to instruct the bearer network to stop monitoring corresponding to the value of the third monitoring identifier attribute.

12. The method according to claim 5, after monitoring the event to be monitored according to the attribute of the resource, further comprising:
sending a third monitoring updating request message to the bearer network, wherein the third monitoring updating request message contains the third monitoring identifier attribute of the resource and at least one of attributes obtained by updating the identifier attribute of the target to be monitored, the attribute of the event to be monitored, the attribute indicating the processing manner performed after occurrence of the event, the monitoring time length attribute, the monitoring report number attribute, the attribute indicating the time when the monitoring ends and the attribute indicating the time when the monitoring starts, respectively.

13. A monitoring management device, comprising:
a processor; and
a memory for storing instructions executable by the processor;
wherein the processor is configured to
receive from a monitoring initiator a request message for requesting creation of a resource, wherein the resource is configured for monitoring management, and the request message contains at least the following parameter: an event to be monitored;
create the resource according to the request message, and create an attribute of the resource according to the parameter contained in the request message;
monitor the event to be monitored according to the attribute of the resource to obtain a monitoring report; and
receive and store the monitoring report, wherein the monitoring report contains a monitoring result.

14. The device according to claim 13, wherein the request message further comprises at least one of an identifier of a target to be monitored, a first monitoring identifier for identifying a monitoring task, a processing manner performed after occurrence of the event to be monitored, a monitoring time length, a monitoring report number, a time when a monitoring ends and a time when a monitoring starts.

15. The device according to claim 14, wherein the processor is further configured to:
send a monitoring request message to a bearer network according to the attribute of the resource, wherein the monitoring request message is configured to instruct the bearer network to monitor the event to be monitored, and the monitoring request message contains the attribute of the resource.

16. The device according to claim 15, the processor is further configured to:
receive a second monitoring identifier allocated by the bearer network; and
store the received second monitoring identifier in the resource.

17. The device according to claim 14, the processor is further configured to:
allocate a third monitoring identifier; and
create a third monitoring identifier attribute for the resource, and set a value of the created third monitoring identifier attribute to be the allocated third monitoring identifier.

18. The device according to claim 15, the processor is further configured to:
send a first monitoring stopping request message to the bearer network, wherein the first monitoring stopping request message contains a first monitoring identifier attribute of the resource, and the first monitoring stopping request message is configured to instruct the bearer network to stop monitoring corresponding to a value of the first monitoring identifier attribute.

19. The device according to claim 15, the processor is further configured to:
send a first monitoring updating request message to the bearer network, wherein the first monitoring updating request message contains the first monitoring identifier attribute of the resource and at least one of attributes obtained by updating an identifier attribute of the target to be monitored, an attribute of an event to be monitored, an attribute indicating a processing manner performed after occurrence of the event, a monitoring time length attribute, a monitoring report number attribute, an attribute indicating a time when a monitoring ends and an attribute indicating a time when a monitoring starts, respectively.

20. The device according to claim 13, wherein the processor is further configured to:
store the monitoring report in the resource; and/or,
store the monitoring report in another pre-created resource except the resource.

21. The device according to claim 16, the processor is further configured to:
after the received second monitoring identifier is stored in the resource, send a second monitoring stopping request message to the bearer network, wherein the second monitoring stopping request message contains a second monitoring identifier attribute of the resource, and the second monitoring stopping request message is configured to instruct the bearer network to stop monitoring corresponding to a value of the second monitoring identifier attribute.

22. The device according to claim 16, the processor is further configured to:
after the received second monitoring identifier is stored in the resource, send a second monitoring updating request message to the bearer network, wherein the second monitoring updating request message contains the second monitoring identifier attribute of the resource and at least one of attributes obtained by updating the identifier attribute of the target to be monitored, the attribute of the event to be monitored, the attribute indicating the processing manner performed after occurrence of the event, the monitoring time length attribute, the monitoring report number attribute, the attribute indicating the time when the monitoring ends and the attribute indicating the time when the monitoring starts, respectively.

23. The device according to claim 17, the processor is further configured to:
after the event to be monitored is monitored according to the attribute of the resource, send a third monitoring stopping request message to the bearer network, wherein the third monitoring stopping request message contains the third monitoring identifier attribute of the resource, and the third monitoring stopping request message is configured to instruct the bearer network to stop monitoring corresponding to the value of the third monitoring identifier attribute.

24. The device according to claim 17, the processor is further configured to:
after the event to be monitored is monitored according to the attribute of the resource, send a third monitoring updating request message to the bearer network, wherein the third monitoring updating request message contains the third monitoring identifier attribute of the resource and at least one of attributes obtained by updating the identifier attribute of the target to be monitored, the attribute of the event to be monitored, the attribute indicating the processing manner performed after occurrence of the event, the monitoring time length attribute, the monitoring report number attribute, the attribute indicating the time when the monitoring ends and the attribute indicating the time when the monitoring starts, respectively.

25. A non-transitory computer storage medium having stored therein instructions that, when executed by a processor, cause a computing device to execute a monitoring management method, the method comprising:
receiving from a monitoring initiator a request message for requesting creation of a resource, wherein the resource is configured for monitoring management, and the request message contains at least the following parameter: an event to be monitored;
creating the resource according to the request message, and creating an attribute of the resource according to the parameter contained in the request message;
monitoring the event to be monitored according to the attribute of the resource to obtain a monitoring report; and
receiving and storing the monitoring report, wherein the monitoring report contains a monitoring result.
